(19) United States
(12) Patent Application Publication
(10) Pub. No.: US 2025/0371670 A1
(43) Pub. Date: Dec. 4, 2025

(54) CHECK IMAGE RANDOM DATE GENERATION

(71) Applicant: Capital One Services, LLC, McLean, VA (US)

(72) Inventors: Thomas Oliver CANTRELL, Maidens, VA (US); Joseph James FORD, III, Manakin Sabot, VA (US)

(73) Assignee: Capital One Services, LLC, McLean, VA (US)

(21) Appl. No.: 18/733,251

(22) Filed: Jun. 4, 2024

(51) Int. Cl. G06T 5/50; G06T 5/20; G06T 7/62; G06T 11/60; G06V 10/25; G06V 10/56

(52) U.S. Cl. CPC G06T 5/50; G06T 5/20; G06T 7/62; G06T 11/60; G06V 10/25; G06V 10/56; G06T 2207/20081; G06T 2207/20221

(57) ABSTRACT

Disclosed herein are system, device, method and/or computer program product embodiments for training a machine learning model for processing an electronic document. To train the machine learning model, an embodiment may first collect electronic documents from a database. The embodiment may then detect a region of interest in each electronic document. The embodiment may then generate a random replacement image for each detected region of interest. The embodiment may then replace each detected region of interest with the corresponding generated random image. The embodiment may then generate a training set comprising the modified images. Finally, the embodiment may train the machine learning model using the generated training set.

### BACKGROUND

Neural networks have demonstrated remarkable capabilities in various domains. Neural networks learn from vast amounts of training data to identify patterns and make predictions. However, as neural networks progress through training, they encounter a problem known as overfitting. Overfitting occurs when the model becomes too sensitive to the training data, causing it to memorize answers rather than learning the underlying features and basing decisions on the test data. Instead of generalizing to new data, the overfitted models pick up on noise and irrelevant patterns, leading to lower accuracy and reliability in real-world scenarios.

The consequences of overfitting can be especially severe in domains where accuracy is absolutely necessary. For example, in the context of financial software, accuracy and generalizability of neural networks are critical. Financial institutions rely on these models to assess risk, detect fraud, and make decisions based on complex data. When a neural network overfits, it may provide incorrect predictions, potentially leading to costly errors and significant financial losses.

### BRIEF DESCRIPTION OF THE DRAWINGS

The accompanying drawings are incorporated herein and form a part of the specification.

FIG. 1 is a block diagram illustrating example for an image augmentation system (IAS), according to some embodiments.

FIG. 2 illustrates an example electronic document modification, according to some embodiments.

FIG. 3 illustrates a flow diagram of an example method, according to some embodiments.

FIG. 4 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method, and/or computer program product embodiments, and/or combinations and sub-combinations thereof, for training a machine learning model for processing an electronic document, which may result in a more generalizable and more accurate model.

In general, the first step in training a machine learning model is data preparation. In this step, available data is cleaned, preprocessed, and split into training and testing sets. For example, in the financial space, the training and testing sets may include images of checks and corresponding information such as payer customer name and address, check number, payee, payment amount, payment written amount, date, bank routing number, and payer account number. The training set is used to teach the model and the testing set is used to evaluate the model performance on data it has not seen before. During training, the model iteratively adjusts its internal parameters to minimize the error between its predictions and the actual outputs of the training data. This process continues until the model performance reaches a satisfactory level.

However, one of the potential challenges faced during training is the limited size and diversity of available data. When a model is trained on a small or biased dataset, it may struggle to generalize to new, unseen data. For example, in the financial space, certain data fields such as date and bank routing number have limited diversity which can negatively affect the model training process. The date field of a check image is limited to present and past date values, thus a machine learning model would not see any dates from the future during training. For example, suppose a machine learning model was trained on check images dated between 2000 and 2024. The model may incorrectly learn that the year will always begin with a 20, and the third digit can only be 0, 1, or 2. When a check from 2030 enters the system, the model may incorrectly predict the third digit of the year as a 2. A user would want the model to base its prediction from the underlying features of the test data and not just simply memorize irrelevant patterns in the training data due to a lack of diversity.

Similarly, bank routing numbers are limited to existing banks and their corresponding routing numbers. There are approximately 28,000 active nine-digit routing numbers out of the 363,000 possible bank routing numbers. A training data set may also only consist of checks from a smaller subset of the 28,000 active numbers. For example, the data set may not include checks from lesser known banks. This reduced number may lead to potential overfitting of the model. For example, consider a scenario where a machine learning model is trained on a dataset, where a particular routing number (e.g. 123456789) is frequently associated with large payment amounts, such as transactions over $10,000. During training, the neural network may inadvertently learn the association between this routing number and high payment amounts. When the trained model is presented with new, unseen data, the model may incorrectly assume that any transaction with routing number 123456789 will be a high-value payment, even if the actual payment amount is much smaller. In another example, suppose in the training set, transactions with another particular routing number (e.g. 234567890) are more prevalent during the month of December due to seasonal or industry-specific factors. The model may overfit to this pattern and associate routing number 23456790 with December transactions. As a result, the model may incorrectly assume that any transaction with routing number 234567890 is likely to occur in December, even if the transaction takes place in a different month.

Account numbers may also contain biases that can lead to overfitting. When assigning account numbers, financial institutions may follow certain numbering conventions for a number of reasons. In one non-limiting example, financial institutions may assign certain prefixes to denote an account's type, such as a ‘0’ for a checking account, a ‘1’ for a savings account, or a ‘2’ for a money market account. As such, this may skew account numbers towards starting with 0, 1, or 2. Financial institutions may also include branch codes in an account number to help track accounts by where they were opened. Account numbers may also include check digits to help detect and prevent any errors when transmitting or entering account numbers. The model may unintentionally pick up on these patterns and erroneously assume relationships that could lead to incorrect predictions down the line. For example, checking accounts may be associated with higher transaction amounts than savings accounts in a particular financial institution. As a result, an overfitted model may favor higher transaction amounts when dealing with account numbers beginning with 0 and misread its input data.

Various embodiments in accordance with the present disclosure overcome the aforementioned issues by augmenting a plurality of electronic documents prior to training a machine learning model with randomly generated synthetic document sections. A plurality of documents may first be collected to initiate the data preparation process. For example, a plurality of check images may be collected. Then, using bounding box detection techniques, a region of interest is detected for each electronic document. For example, in the context of financial software, the region of interest may be a data field of a check, such as but not limited to payer customer name and address, check number, payee, payment amount, payment written amount, date, bank routing number, and payer account number. A random replacement document section image for the region of interest may then be generated through a script for each electronic document. For example, a script may generate a synthetic handwritten image of the date “6 Mar. 2046” for a document. A script may generate another image of the date “Feb. 17, 2031”. The region of interest would then be replaced by the generated replacement document section image. Additional destructive augmentation techniques may also be applied to the modified document. For example, the electronic document's colors may be inverted. Finally, a training data set is created using the plurality of augmented electronic documents and is used to train a machine learning model. The resulting machine learning model would see more diverse training data, thus increasing generalizability and accuracy in real-world applications.

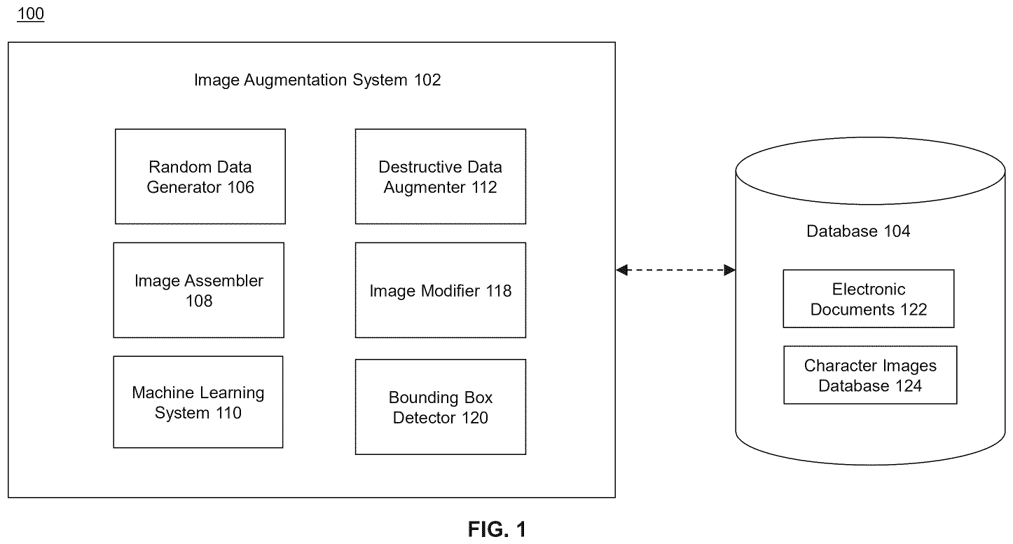

FIG. 1 is a block diagram of an example system 100 illustrating example functionality for an image augmentation system (IAS) 102, according to some embodiments. The example system 100 is provided for the purpose of illustration only and does not limit the disclosed embodiments. IAS 102 may augment electronic document images to train a machine learning model with increased generalizability and accuracy. Example system 100 may include IAS 102 and database 104. IAS 102 may include a random data generator 106, image assembler 108, machine learning system 110, destructive data augmenter 112, image modifier 118, and bounding box detector 120. Database 104 may include electronic documents 122 and character image database 124.

In some embodiments, IAS 102 may collect electronic documents 122 from database 104. Once electronic documents 122 are collected, IAS 102 may employ bounding box detector 120 to identify a region of interest for each of the collected electronic documents. In some embodiments, bounding box detector 120 may attempt to locate the date section of an electronic document. Bounding box detector 120 may be a deep learning model, such as but not limited to a convolutional neural network (CNN) or a region-based CNN (R-CNN). For example, training the bounding box detector 120 may involve collecting a plurality of check images and manually annotating the date sections with a bounding box. The plurality of check images may be used to train bounding box detector 120 to recognize the visual patterns of date sections. When training is complete, bounding box detector 120 may be employed to detect date sections of new, unseen data. The same approach may be extended to detect other regions of interest on an electronic document. For example, bounding box detector 120 may be trained to identify a check routing number, check accounting number, or check serial number.

Upon detecting the region of interest, IAS 102 may employ random data generator 106 to generate random data parameters for a replacement image. In some embodiments, random data generator 106 may select a random date value and random date format. The random date value may include dates from the past and the future. Random data generator 106 may select from date formats such as, but are not limited to: Month name-Day-Year (Feb. 15, 2020), Day-Month name-Year (15 Feb. 2020), Month abbreviation-Day-Year (Feb. 15, 2020), MM/DD/YYYY (02/15/2020), DD/MM/YYYY (15/02/2020), YYYY/MM/DD (2020/02/15), and MM/DD/YY (02/15/20). In some embodiments, random data generator 106 may also select whether the date may be handwritten or printed. For example, random data generator 106 may randomly select the date “Aug. 7, 2041”, the format “Month abbreviation-Day-Year”, and for the date to be handwritten.

IAS 102 may employ image assembler 108 to assemble a replacement image for the region of interest based on the data generated by random data generator 106. In some embodiments, image assembler 108 may perform different operations depending on the format and content of the generated data. For example, if the format of the generated data is handwritten, image assembler 108 may employ an image assembling algorithm to produce the replacement image. In some embodiments, image assembler 108 may randomly retrieve character images from character images database 124 that correspond to the characters of the generated data. In some embodiments, character image database 124 may be the Extended Modified National Institute of Standards and Technology (EMNIST) dataset. Character image database 124 may also be a manually curated dataset. For example, character image database 124 may be produced by manually drawing and capturing individual characters in different handwriting styles. In an example, image assembler 108 may receive generated data “Aug. 7, 2041” in the format “Month Abbreviation-Day-Year” from random data generator 106. Image assembler 108 may then retrieve random character images of the handwritten characters ‘A’, ‘u’, ‘g’, ‘7’, ‘,’, ‘2’, ‘0’, ‘4’, and ‘1’ from character image database 124. Upon retrieving random character images, image assembler 108 may join the character images together to produce an initial replacement image for the detected region of interest. In some embodiments, image assembler 108 may scale the initial replacement image to fit within the detected region of interest. In some embodiments, the character images may possess a transparent background. In some embodiments, image assembler 108 may also apply a transparent background to the initial replacement image using image processing techniques. A transparent background may facilitate a seamless electronic document modification.

In another example, if the format of the generated data is printed, image assembler 108 may simply produce an image of the printed content of the region of interest. Image assembler 108 may rely on a default font to produce the printed content of the region of interest. In some embodiments, image assembler 108 may employ font recognition techniques to identify any other printed fonts used in the electronic document and produce a replacement image using the identified fonts. For example, image assembler 108 may employ a trained deep learning model to identify the font used in the electronic document such as but not limited to WhatTheFont and Tesseract.

In real-world situations, handwritten text may have inconsistent kerning between characters in a line of text. As used herein, “kerning” refers to the spacing between individual letters or characters. To capture this phenomenon, image assembler 108 may determine a random kerning for each character image based on the size of the detected region of interest and the generated data. In some embodiments, image assembler 108 may select a greater kerning if empty space remains after image assembler 108 fits the replacement image within the detected region of interest. In some embodiments, image assembler 108 may select a lesser kerning if the content of the generated data is longer in length compared to the content of the detected region of interest. For example, a handwritten “Nov. 30, 2030” may require less kerning when replacing a handwritten “Jan. 1, 2021”.

Image assembler 108 may apply additional transformations to the character images to add diversity to the replacement images. In some embodiments, image assembler 108 may randomly apply a scaling factor to each character image. For example, image assembler 108 may randomly select the scaling factor 1.02 and scale an image by 1.02×. In another example, image assembler 108 may randomly select the scaling factor 0.97 and scale the image by 0.97×. In some embodiments, image assembler 108 may apply a random rotation to the character images. For example, image assembler 108 may randomly select the rotation 5° and rotate the image by 5 degrees. In another example, image assembler 108 may randomly select the rotation −2° and rotate the image by −2 degrees. In some embodiments, image assembler 108 may apply random horizontal or vertical offsets to each character image. For example, image assembler 108 may randomly select the horizontal offset 2 px and the vertical offset −3 px. Image assembler 108 may then horizontally offset the character image 2 pixels to the right and vertically offset the character image 3 pixels down. By increasing the diversity of the replacement images, image assembler 108 may increase the generalizability of machine learning system 110 after the model training process.

IAS 102 may employ image modifier 118 to replace the detected regions of interest in electronic documents 122 with the corresponding assembled replacement images produced by image assembler 108. Depending on the state of the original electronic documents, image modifier 118 may need to apply transformations to the assembled replacement images before replacing the detected region of interest. Blindly replacing the detected region of interest with the generated image may cause the modified image to appear unnatural or to be easier to process. This may result in introducing unnecessary noise into the training data and less generalizability.

For example, a check image may be rotated sideways during the scanning process. Replacing a sideways date section with a straight date section may cause the machine learning model to incorrectly assume that date sections are always straight. In this example, blindly replacing the date section may also inadvertently cause the model to be less robust when handling real check images. Using image processing and analysis techniques, image modifier 118 may analyze the state of the original electronic document and apply relevant transformations to the replacement image. After applying the appropriate transformations, image modifier 118 may then replace the region of interest with the modified generated image. In some embodiments, image modifier 118 may employ image processing tools and libraries such as but not limited to OpenCV, Pillow, scikit-image, and imageio.

In real-world situations, electronic documents may vary in quality. For example, financial documents such as checks may come in varying degrees of quality. Some checks may be generated electronically and possess higher quality. Other checks may be physically scanned. Depending on the scanning process, check quality may be negatively affected. For example, a scanned check may appear grainy due to a dirty scanner or camera. Certain sections of a check may also be blurry or hard to read due to poor focus or slow shutter speed. A check may also acquire one or more ink streaks due to a faulty printer or scanner.

To account for these varying levels of electronic document quality, destructive data augmenter 112 may synthetically reduce the quality of the modified electronic documents produced by image modifier 118. In some embodiments, destructive data augmenter 112 may employ destructive data augmentation techniques to the modified electronic documents. As used herein, “destructive data augmentation” involves intentionally applying destructive techniques to a training dataset to generate new data points and reduce model overfitting. For example, destructive data augmenter 112 may randomly apply techniques to the modified documents such as but not limited to inverting color, applying a grain filter, adding a synthetic ink streak, and removing standard sections. By applying these destructive techniques and training a model with the augmented images, the model may generalize better to unseen data, which may vary in quality.

In some embodiments, destructive data augmenter 112 may invert the color of the electronic document. Real-world electronic documents may come in varying colors. Occasionally, real-world electronic documents may also come with inverted colors. Electronic documents may have their colors inverted accidentally during the scanning process Electronic documents may also have their colors inverted intentionally. For example, an electronic document may have its color inverted with the intention to increase readability or simplify processing. By inverting colors of electronic documents, destructive data augmenter 112 may account for these variations in the training data set and increase the generalizability of machine learning system 110.

In some embodiments, destructive data augmenter 112 may also remove standard sections of the electronic document by applying a mask (i.e. masking). As used herein, a “mask” refers to concealing a specific section of an electronic document. Masking certain sections of training data may lead to less model overfitting and more generalizability. For example, in the context of check images, the amount value may appear in multiple locations on a check in a written and/or numeric format. During training, a machine learning model may favor the examination of one section to extract the amount value. A machine learning model may be biased to one location because one location may be easier to analyze. A machine learning model may also bias to one location entirely at random. With real check images, sometimes one amount location may be unavailable or hard to read. A biased machine learning model may attempt a prediction on an unreadable amount section and produce incorrect results. A machine learning model trained on augmented data with masked sections may learn to examine both the written and numeric amount values when making a prediction. This may lead to less overfitting and more generalizability on new, unseen check images.

After performing the electronic document modifications, IAS 102 may create a training data set and train machine learning system 110 using the training data set. Machine learning system 110 may be a computer vision model configured to process images. For example, machine learning system 110 may be trained to perform text recognition on check images. Given an image of a check, machine learning system 110 may identify handwritten and printed characters within certain regions of interest such as but not limited to payer customer name and address, check number, payee, payment amount, payment written amount, date, bank routing number, and payer account number. By training machine learning system 110 with augmented data, machine learning system may obtain higher accuracy and generalizability when examining real-world electronic documents.

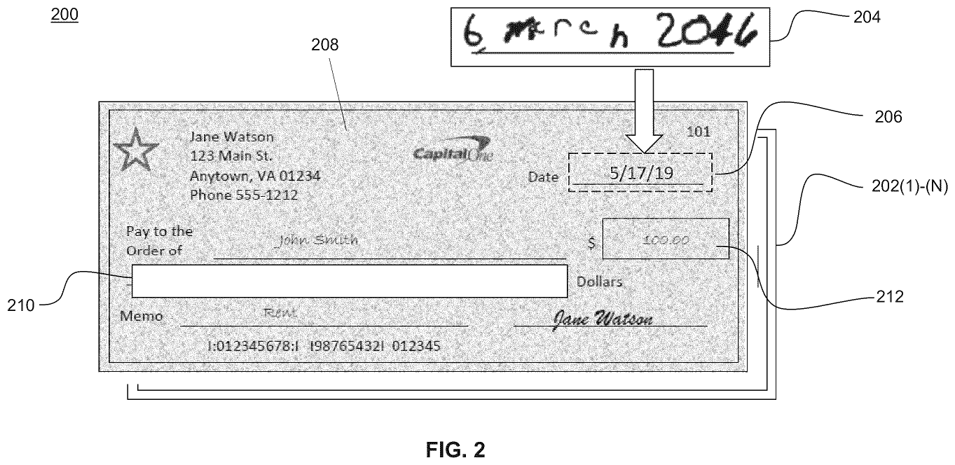

FIG. 2 illustrates an example electronic document modification 200, according to some embodiments. Electronic document modification 200 shall be described with reference to IAS 102 (of FIG. 1). However, electronic document modification 200 is not limited to that example system. The electronic document modification provided in FIG. 2 is merely exemplary, and one skilled in the relevant art(s) will appreciate that many approaches may be taken to provide a suitable electronic document modification 200 in accordance with this disclosure. In some embodiments, electronic document modification 200 may include electronic documents 202(1)-(N), generated image 204, region of interest 206, grain filter 208, masked amount section 210, and unmasked amount section 212. Electronic documents 202(1)-(N) may be an example of electronic documents 122 (of FIG. 1).

Region of interest 206 may encompass a section of electronic documents 202(1)-(N) to be modified. In some embodiments, region of interest 206 may be detected using bounding box detection techniques. For example, bounding box detection techniques may include using a deep learning model, such as but not limited to a convolutional neural network (CNN) or a region-based CNN (R-CNN). In some embodiments, training the deep learning model may involve supervised learning by collecting a plurality of electronic document images and manually annotating the relevant region of interest of each image. For example, the date section of a check image may be manually annotated. This plurality of check images may be used to train the deep learning model to recognize the date section of a check image in a supervised context. When training error reaches a satisfactory level, the deep learning model may be deployed to detect the date section of new, unseen check images.

Generated image 204 may replace region of interest 206 as part of a data augmentation process. In some embodiments, an IAS 102 (of FIG. 1) may assemble generated image 204 and modify region of interest 206. Parameters of region of interest 206 may be generated at random initially. For example, if region of interest 206 is a date section of a check image, IAS 102 may generate a random date “Mar. 6, 2046” and a random format handwritten Day-Month name-Year. IAS 102 may then assemble generated image 204 by randomly sampling character images from a database that correspond to each character in the random date. For example, IAS 102 may assemble generated image 204 using randomly sampled characters ‘6’, ‘M’, ‘a’, ‘r’, ‘c’, ‘h’, ‘2’, ‘0’, ‘4’, and ‘6’.

IAS 102 may perform further modifications to generated image 204, such as but not limited to selecting a random kerning between each character image, randomly scaling and rotating each character image, and adding random horizontal and vertical offsets to each character image. For example, IAS 102 may randomly select a negative kerning like the kerning between character images ‘M’ and ‘a’ in generated image 204. After performing the modifications, IAS 102 may modify electronic documents 202(1)-(N) by replacing region of interest 206 with generated image 204. IAS 102 may employ image processing tools and libraries such as but not limited to OpenCV, Pillow, scikit-image, and imageio.

IAS 102 may decide at random whether to destructively augment electronic documents 202(1)-(N). For example, IAS 102 may decide to modify electronic document 202(1) by applying grain filter 208. By applying grain filter 208, IAS 102 may further increase the diversity of the training set. As a result, the training set may generalize better to real world data. For example, a check image may appear grainy due to a dirty scanner or camera. Without including any grainy check images during training, the trained machine learning model may produce incorrect predictions when facing an unseen grainy image. By destructively augmenting the training data set, the trained machine learning model may become more robust.

Similarly, IAS 102 may also further modify electronic documents 202(1)-(N) by removing standard sections of the electronic document. For example, IAS 102 may cover a written amount section of electronic document 202(1), creating masked amount section 210. Masking certain sections of training data may also lead to less model overfitting and more generalizability. In this example, the amount value of a check may appear in multiple locations in a written and/or numeric format (i.e. unmasked amount section 212). During training, a machine learning model may favor one format when making predictions. This favoring may occur entirely at random or due to one format being easier to analyze. By destructively augmenting the check images in this manner, a trained machine learning model may learn to examine both the written and numeric amount values when making a prediction. In this case, the machine learning model may need to examine unmasked amount section 212 to extract the correct amount of $100, since the written amount section is unavailable. This process may lead to less overfitting and more generalizability on new, unseen check images.

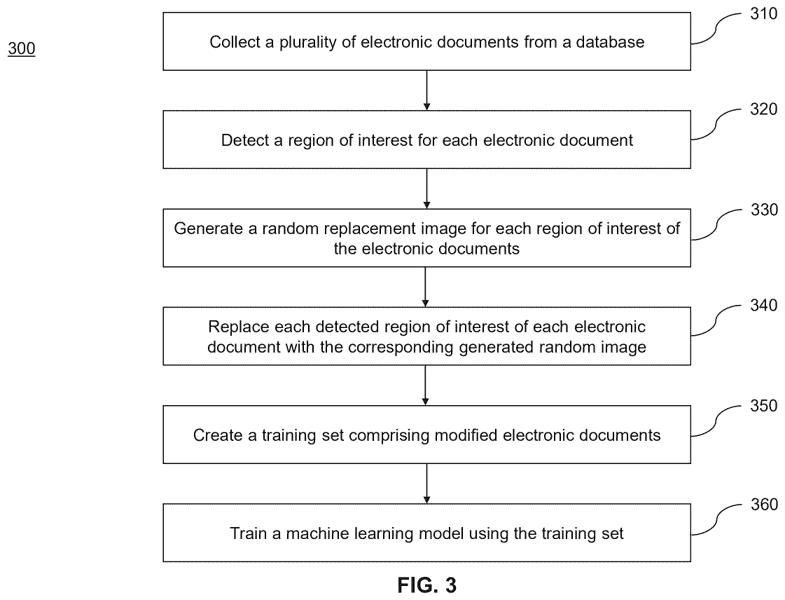

FIG. 3 is a flowchart 300 illustrating example operations for training a machine learning model for processing an electronic document, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIG. 1. However, method 300 is not limited to that example embodiment.

In 310, an image augmentation system may collect a plurality of electronic documents from a database. For example, IAS 102 may retrieve electronic documents 122 from database 104. In some embodiments, electronic documents 122 may be a plurality of check images.

In 320, an image augmentation system may detect a region of interest for each electronic document. For example, upon collecting electronic documents 122, IAS 102 may employ bounding box detector 120 to detect a region of interest for each electronic document. IAS 102 may provide electronic documents 122 to bounding box detector 120 and receive bounding box locations for a region of interest for each electronic document. Bounding box detector 120 may be a deep learning model trained to identify certain sections of electronic documents 122. In some embodiments, bounding box detector 120 may detect a date region from each check image.

In 330, an image augmentation system may generate a random replacement image for each region of interest of the electronic documents. For example, IAS 102 may employ random data generator 106, and image assembler 108 to generate the replacement images. Random data generator 106 may first generate random data parameters for a replacement image. In some embodiments, random data generator 106 may select a random date value and random date format. For example, random data generator 106 may randomly select the date “Aug. 7, 2041”, the format “Month abbreviation-Day-Year”, and for the date to be handwritten.

IAS 102 may then employ image assembler 108 to assemble a replacement image for the region of interest. In some embodiments, image assembler 108 may perform different operations depending on the format and content of the data generated by random data generator 106. For example, if the format of the generated data is handwritten, image assembler 108 may employ an image assembling algorithm to produce the replacement image. The image assembling algorithm may involve retrieving corresponding character images from character image database 124 in database 104 and joining the character images together to create an initial replacement image. In some embodiments, image assembler 108 may scale the initial replacement image to fit within the detected region of interest.

Image assembler 108 may apply various additional randomization factors to the initial replacement image. In some embodiments, image assembler 108 may randomize the kerning between each character image. Image assembler 108 may also apply random transformations to each character image, such as but not limited to scaling the character image, rotating the image, or adding horizontal and/or vertical offsets to the image. After applying the various randomization factors to the initial replacement image, IAS 102 thereby generates a random replacement image to replace the detected region of interest.

In 340, an image augmentation system may replace each detected region of interest of each electronic document with the corresponding generated random image. For example, IAS 102 may employ image modifier 118 to replace the detected region of interest. Depending on state of the original electronic documents, image modifier 118 may need to apply additional transformations to the generated image before replacing the detected region of interest. For example, if an electronic document is rotated sideways, image modifier 118 may apply a rotation to the generated image to match the rotation of the electronic document. After applying any relevant transformations, image modifier 118 may replace the detected region of interest for each electronic document. In some embodiments, image modifier 118 may employ image processing tools and libraries such as but not limited to OpenCV, Pillow, scikit-image, and imageio.

In 350, an image augmentation system may create a training set comprising the modified electronic documents. For example, IAS 102 may create a training data set using the augmented check images. To prepare the training data set, IAS 102 may label each augmented check image using the random date value generated by random data generator 106. These labels may serve as the ground truth when training machine learning system 110 in a supervised learning environment. As used herein, “ground truth” refers to the correct answer or answers to the problem or scenario that a machine learning system is being trained on. After labeling the augmented check images, IAS 102 may divide the labeled augmented check images into a training data set and a testing data set.

In 360, an image augmentation system may train a machine learning model using the training set. For example, IAS 102 may train machine learning system 110 in a supervised learning context using the labeled augmented check images. In some embodiments, IAS 102 may train machine learning system 110 to perform text recognition on the labeled augmented check images. During the training process, machine learning system 110 may learn to identify handwritten and printed characters within a date section of a check. In some embodiments, machine learning system 110 may initialize a set of internal parameters. As training progresses, machine learning system 110 may iteratively adjust its internal parameters to minimize the error between its predictions and the ground truth labels of the training data. Machine learning system 110 may also be evaluated using the testing data set to simulate its performance on new, unseen data. If the testing error is too high, IAS 102 may continue to train machine learning system 100 until the model performance reaches a satisfactory level.

### Example Computer System

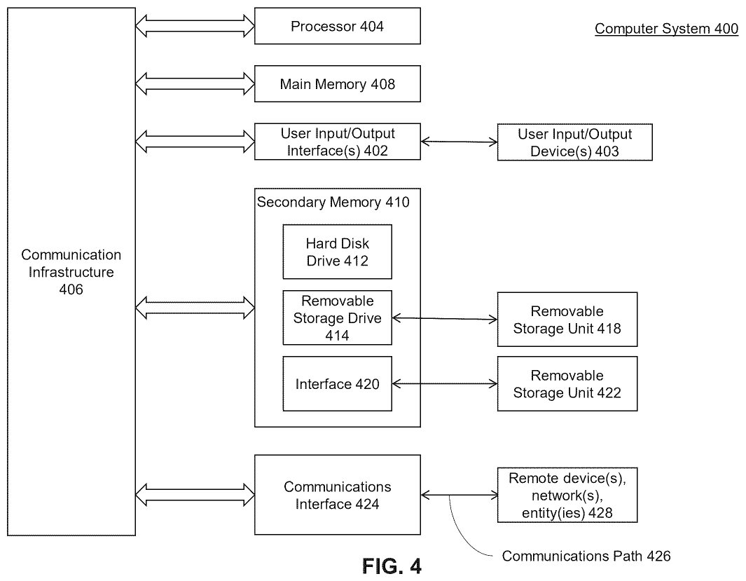

FIG. 4 depicts an example computer system useful for implementing various embodiments.

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method of training a machine learning model for processing an electronic document, comprising:
detecting a region of interest for each of a plurality of electronic documents using a bounding box detection mechanism;
generating a random replacement image for each region of interest of the plurality of electronic documents utilizing a script;
replacing each detected region of interest of each electronic document with the corresponding generated random image to create a modified plurality of electronic document images;
generating a training set comprising the modified plurality of electronic document images; and
training the machine learning model using the training set.

2. The computer-implemented method of claim 1, wherein the generating the random replacement image comprises:
selecting one or more parameters for each region of interest at random;
determining a size of each detected region of interest; and
assembling a replacement image for each region of interest based on the selected parameters and the size of each detected region of interest.

3. The computer-implemented method of claim 2, wherein the region of interest comprises a date section.

4. The computer-implemented method of claim 3, wherein the one or more parameters comprises at least a date value and a date format.

5. The computer-implemented method of claim 4, wherein the assembling the replacement image comprises:
retrieving a random handwritten character image from a database for each character of the selected date value;
determining a random kerning for each character image based on the size of the detected date section and the selected date; and
joining the character images sequentially based on the selected date and the random kerning for each character image.

6. The computer-implemented method of claim 1, wherein the creating the training set comprises combining the modified plurality of electronic documents with a second plurality of unmodified electronic documents from a database.

7. The computer-implemented method of claim 1, further comprising:
applying a destructive technique to each modified electronic document.

8. The computer-implemented method of claim 7, wherein the destructive technique comprises at least one of the following:
inverting the colors of the modified electronic document;
applying a grain filter to the modified electronic document;
adding a synthetic ink streak to the modified electronic document; and
removing standard sections of the modified electronic document.

9. A system, comprising:
one or more memories;
at least one processor each coupled to at least one of the memories and configured to perform operations comprising:
detecting a region of interest for each of a plurality of electronic documents using a bounding box detection mechanism;
generating a random replacement image for each region of interest of the plurality of electronic documents utilizing a script;
replacing each detected region of interest of each electronic document with the corresponding generated random image to create a modified plurality of electronic document images;
generating a training set comprising the modified plurality of electronic document images; and
training the machine learning model using the training set.

10. The system of claim 9, wherein the generating the random replacement image comprises:
selecting one or more parameters for each region of interest at random;
determining a size of each detected region of interest; and
assembling a replacement image for each region of interest based on the selected parameters and the size of each detected region of interest.

11. The system of claim 10, wherein the region of interest comprises a date section.

12. The system of claim 11, wherein the one or more parameters comprises at least a date value and a date format.

13. The system of claim 12, wherein the assembling the replacement image comprises:
retrieving a random handwritten character image from a database for each character of the selected date value;
determining a random kerning for each character image based on the size of the detected date section and the selected date; and
joining the character images sequentially based on the selected date and the random kerning for each character image.

14. The system of claim 9, wherein the creating the training set comprises combining the modified plurality of electronic documents with a second plurality of unmodified electronic documents from a database.

15. The system of claim 9, the operations further comprising:
applying a destructive technique to each modified electronic document.

16. The system of claim 15, wherein the destructive technique comprises at least one of the following:
inverting the colors of the modified electronic document;
applying a grain filter to the modified electronic document;
adding a synthetic ink streak to the modified electronic document; and
removing standard sections of the modified electronic document.

17. A non-transitory computer-readable medium having instructions stored thereon that, when executed by at least one computing device, causes the at least one computing device to perform operations comprising:
detecting a region of interest for each of a plurality of electronic documents using a bounding box detection mechanism;
generating a random replacement image for each region of interest of the plurality of electronic documents utilizing a script;
replacing each detected region of interest of each electronic document with the corresponding generated random image to create a modified plurality of electronic document images;
generating a training set comprising the modified plurality of electronic document images; and
training the machine learning model using the training set.

18. The non-transitory computer-readable medium of claim 17, wherein the generating the random replacement image comprises:
selecting one or more parameters for each region of interest at random;
determining a size of each detected region of interest; and
assembling a replacement image for each region of interest based on the selected parameters and the size of each detected region of interest.

19. The non-transitory computer-readable medium of claim 18, wherein the region of interest comprises a date section.

20. The non-transitory computer-readable medium of claim 19, wherein the one or more parameters comprises at least a date value and a date format.
